(19) United States
(12) Patent Application Publication
(10) Pub. No.: US 2026/0153833 A1
(43) Pub. Date: Jun. 4, 2026

(54) PROCESSING CARTRIDGE

(71) Applicant: Zhuhai Ninestar Information Technology Co. , Ltd, Zhuhai (CN)

(72) Inventors: Hailong MA, Zhuhai (CN); Changbiao WANG, Zhuhai (CN); Qingrui ZHU, Zhuhai (CN); Chaoxing LIU, Zhuhai (CN)

(21) Appl. No.: 19/465,708

(22) Filed: Jan. 30, 2026

Related U.S. Application Data
(63) Continuation of application No. PCT/CN2024/105010, filed on Jul. 11, 2024.

(30) Foreign Application Priority Data
Jul. 31, 2023 (CN) 202322043869.1

(51) Int. Cl. G03G 21/18; G03G 21/16

(52) U.S. Cl. CPC G03G 21/186; G03G 21/1647; G03G 21/1864; G03G 2221/1654; G03G 2221/1884

(57) ABSTRACT

To be detachably accommodated in an electronic imaging device including a braking force applying assembly and a drive force transmission member, a processing cartridge includes: a drum frame; a photosensitive drum rotatably supported on the drum frame; a drum coupling, configured at one end of the photosensitive drum, to engage with the drum drive transmission unit and receive drive force to rotate in rotation direction A, where the drum coupling includes a compression portion acting on a braking force applying assembly, and during engagement of the drum coupling with the drum drive transmission unit, the drum coupling abuts against the braking force applying assembly, causing the braking force applying assembly to move in the retraction direction, thereby reducing or eliminating abnormal noise during rotation of the drive transmission unit.

### CROSS-REFERENCE TO RELATED APPLICATION(S)

This application claims priority to PCT International Application No. PCT/CN 2024/105010, filed on Jul. 11, 2024, which claims priority to Chinese Patent Application No. 202322043869.1 filed on Jul. 31, 2023, all of which are incorporated herein by reference in their entireties.

### FIELD OF THE TECHNOLOGY

The present disclosure relates to a technical field of electronic imaging device, and in particular, to a processing cartridge.

### BACKGROUND

There is a Chinese patent, CN113574469A, which discloses a drive transmission unit that engages with the drum coupling through multiple components to drive and brake the drum coupling.

In existing technology, printing and developing are achieved through contact between the photosensitive drum on the drum unit and the developing roller on the developing unit of the processing cartridge (toner cartridge). The processing cartridge does not have a cleaning equipment for contacting the photosensitive drum and removing developer (toner) from its surface. That is, the drum unit of the processing cartridge does not have components such as a cleaning blade in contact with the photosensitive drum. Therefore, the torque required for the drum unit 109 (photosensitive drum 104) of the processing cartridge is relatively small. In this structural configuration, the drum unit 109 is susceptible to environmental influences when driven by the printer, and therefore, the drum unit 109 may experience unstable rotational speed due to external factors. For example, in the existing technology, the developing roller 106, the charging roller 105, and the transfer belt 12a are in contact with the photosensitive drum 104. When the magnitude of the frictional force generated between these equipment and the photosensitive drum 104 fluctuates, the speed of the photosensitive drum 104 may fluctuate.

Furthermore, existing processing cartridges apply braking force through an inside of the drive head of the machine. This method of applying requires the machine's drive head and the processing cartridge's drive head to be fully engaged before the OPC braking force may be applied. This machine structure is relatively complex, and the corresponding photosensitive drum coupling structure of the processing cartridge is also complex. During the printer's pre-start detection process, the machine drive head and the processing cartridge drive head need to engage multiple times or operate for a long time before they may effectively cooperate. During this process, noticeable abnormal noise is generated between the braking force application member inside the drive head and the drive head itself.

### SUMMARY

In one aspect, the present disclosure provides a processing cartridge detachably accommodated in an electronic imaging device, where the electronic imaging device includes a drum drive transmission unit, the drum drive transmission unit is axially extendable and retractable, an extension direction is towards the processing cartridge and a retraction direction is away from the processing cartridge, the drum drive transmission unit includes a braking force applying assembly and a drive force transmission member, and the processing cartridge includes: a drum frame; a photosensitive drum rotatably supported on the drum frame; a drum coupling, configured at one end of the photosensitive drum, to engage with the drum drive transmission unit and receive drive force to rotate in rotation direction A, wherein the drum coupling includes a compression portion acting on the braking force applying assembly, and during engagement of the drum coupling with the drum drive transmission unit, the drum coupling abuts against the braking force applying assembly, causing the braking force applying assembly to move in the retraction direction, thereby reducing or eliminating abnormal noise during rotation of the drive transmission unit.

In certain embodiments, the compression portion protrudes from the end surface of the drum coupling, and a number of the compression portions is at least one.

In certain embodiments, the drum coupling includes a drive force receiving portion, the drive force receiving portion protrudes from the end surface of the drum coupling, and a side of the drive force receiving portion on an upstream side in the rotation direction A is a drive force receiving surface.

In certain embodiments, the compression portion is located on the downstream side of the drive force receiving portion in the rotation direction A.

In certain embodiments, a height of the compression portion protruding from the end surface of the drum coupling is less than a height of the drive force receiving portion protruding from the end surface of the drum coupling.

In certain embodiments, the drive force receiving portion is a first protrusion, the compression portion is a second protrusion, and one end of the first protrusion is connected to one end of the second protrusion.

In certain embodiments, the compression portion is a frustoconical structure.

In certain embodiments, an end surface of the drum coupling is configured with a third annular protrusion, and the compression portion is located within an inner circumference of the third annular protrusion.

In certain embodiments, there is an interval between the third annular protrusion and the frustoconical structure, and a height of the frustoconical structure is less than a height of the third annular protrusion.

In certain embodiments, the third annular protrusion has a notch, and one side surface of the notch in the circumference direction is a drive force receiving surface.

In certain embodiments, the third annular protrusion has a notch, and an inner wall of the third annular protrusion includes a drive force receiving portion, a position of the drive force receiving portion corresponds to a position of the notch, and the end surface of the drive force receiving portion facing the retraction direction is a drive force receiving surface.

In certain embodiments, a side surface of the drive force receiving portion includes a braking force receiving surface on a downstream side of the rotation direction A.

In certain embodiments, one end of the braking force receiving surface in the extension direction is connected to one end of the compression portion in the retraction direction.

In certain embodiments, the braking force receiving surface is a surface tilted axially relative to the drum coupling, and the braking force receiving surface is tilted relative to an upstream side of the rotation direction A along the retraction direction.

In certain embodiments, the braking force receiving surface is a flat surface parallel to an axial direction of the drum coupling.

In certain embodiments, the processing cartridge further includes a braking member for providing braking force to the photosensitive drum.

In certain embodiments, a conductive bearing is configured at the other end of the photosensitive drum opposite to the coupling, and the braking member is configured at the conductive bearing and/or the drum coupling.

In certain embodiments, the braking member is a torsion spring.

In certain embodiments, a coil portion of the torsion spring is fitted onto (for example, sleeved on) the outer circumferential surface of the conductive bearing and/or the drum coupling and grips the conductive bearing and/or the drum coupling, and the arm of the torsion spring abuts against the drum frame, when the photosensitive drum rotates, torsion force of the torsion spring generates a braking force on the photosensitive drum.

In certain embodiments, the processing cartridge further includes: a conductive shaft pin, wherein the conductive shaft pin is inserted into the conductive bearing after partially extending through a through hole on the drum frame, the coil portion of the torsion spring is fitted onto (for example, sleeved on) the conductive shaft pin and grips the conductive shaft pin, the arm of the torsion spring abuts against the conductive bearing, and when the photosensitive drum rotates, the torsion force of the torsion spring generates a braking force on the photosensitive drum.

In certain embodiments, an inner wall of the conductive bearing is configured with ribs against which the arm of the torsion spring abuts.

In certain embodiments, the braking member is configured between the conductive bearing and the drum frame, and/or the braking member is configured between the drum coupling and the drum frame; the braking member is capable of being compressed and deformed to generate friction force between the conductive bearing and the drum frame, and/or between the drum coupling and the drum frame; and the friction force provides a braking force acting on the photosensitive drum.

In certain embodiments, the braking member is configured on an end surface or a circumference outer wall of the conductive bearing, and/or the braking member is configured on a circumferential outer wall of the drum coupling.

In certain embodiments, the conductive bearing and/or the drum coupling include an annular groove on circumferential outer wall for accommodating the braking member, and when the braking member is accommodated in the annular groove, at least a portion of which protrudes from the circumference outer wall of the conductive bearing and/or the drum coupling.

In certain embodiments, the braking member is a rubber ring or a rubber gasket.

In certain embodiments, the drum coupling includes a limiting portion for limiting or preventing relative tilting when the drum drive transmission unit engages with the drum coupling.

In certain embodiments, the limiting portion includes a first annular protrusion configured at an outer circumference of the drum coupling.

In certain embodiments, the first annular protrusion protrudes in the retraction direction, and an inner diameter of the first annular protrusion fits an outer diameter of a cylindrical portion of the drive force transmission member; when the drive force transmission member extends in the extension direction and engages with the drum coupling, the cylindrical portion extends into the first annular protrusion and contacts the first annular protrusion.

In certain embodiments, the limiting portion includes a second annular protrusion configured at a central axis of the drum coupling.

In certain embodiments, the second annular protrusion protrudes from the end surface of the drum coupling in the retraction direction, and the inner diameter of the second annular protrusion fits the outer diameter of the positioning protrusion of the drive force transmission member; when the drive force transmission member extends in the extension direction and engages with the drum coupling, a section of the positioning protrusion extends into the second annular protrusion and contacts the second annular protrusion.

In certain embodiments, the limiting portion includes an abutting protrusion extending from the end surface of the drum coupling.

In certain embodiments, the abutting protrusion and the drive force receiving portion are spaced apart in the circumference direction with an interval, and the interval fits the circumference width of the drive force transmission portion of the drive force transmission member; when the drive force transmission member extends in the extension direction and engages with the drum coupling, the drive force transmission portion is at least partially inserted into the interval between the abutting protrusion and the drive force receiving portion and abuts against both.

The beneficial effects of the present disclosure are: the present disclosure reduces or eliminates the problem of abnormal noise during the rotation of the drive transmission unit by providing a compression portion on the drum coupling to interact with the braking force applying assembly; in addition, the processing cartridge is configured with a braking member that provides braking force, such that the photosensitive drum does not rotate when the electronic imaging device is first started, making it easier and faster to stably engage with the drum drive transmission unit and rotate stably.

The compression portion on the drum coupling interacts with the braking force applying assembly to reduce or eliminate abnormal noise during the rotation of the drive transmission unit.

### BRIEF DESCRIPTION OF THE DRAWINGS

FIG. 1 is a schematic diagram of the structure of an existing electronic imaging device;

FIG. 2 is an exploded schematic diagram of the drum drive force transmission unit of an existing electronic imaging device;

FIG. 3 is a schematic diagram of the structure of the existing first braking force engagement member and braking transmission member;

FIG. 4 is a cross-sectional view of the existing drum drive force transmission unit;

FIG. 5 is a cutaway perspective view of the existing drum drive force transmission unit;

FIG. 6 is a schematic diagram of the structure of an existing drum coupling;

FIG. 7 is a schematic diagram of the overall structure of the processing cartridge from one angle according to certain embodiments of the present disclosure;

FIG. 8 is a schematic diagram of the overall structure of the processing cartridge from another angle according to certain embodiments of the present disclosure;

FIG. 9 is a partial exploded view of the processing cartridge according to certain embodiments of the present disclosure;

FIG. 10 is a schematic diagram of the structure of the drum coupling from one angle according to certain embodiments of the present disclosure.

FIG. 11 is a schematic structural diagram of the drum coupling from another angle, according to certain embodiments of the present disclosure from another angle;

FIG. 12 is a schematic structural diagram of the drive force transmission member of the drum drive force transmission unit from one angle;

FIG. 13 is a cross-sectional view of the drum coupling and the drive force transmission member in engagement, according to certain embodiments of the present disclosure;

FIG. 14 is a partial exploded schematic diagram of the conductive end of the processing cartridge, according to certain embodiments of the present disclosure;

FIG. 15 is a cross-sectional view of the conductive end of the processing cartridge, according to certain embodiments of the present disclosure;

FIG. 16 is a schematic diagram of the structure of the drum coupling, according to certain embodiments of the present disclosure;

FIG. 17 is a schematic diagram of the structure of the drum coupling structure, according to certain embodiments of the present disclosure;

FIG. 18 is a schematic diagram of the structure of the drum coupling, according to certain embodiments of the present disclosure;

FIG. 19 is a partial exploded schematic diagram of the conductive end of the processing cartridge, according to certain embodiments of the present disclosure;

FIG. 20 is a cross-sectional view of the conductive end of the processing cartridge, according to certain embodiments of the present disclosure;

FIG. 21 is a partial exploded view of the conductive end of the processing cartridge, according to certain embodiments of the present disclosure;

FIG. 22 is a cross-sectional view of the conductive end of the processing cartridge, according to certain embodiments of the present disclosure;

FIG. 23 is a schematic diagram of the partial structure of the drum coupling and the photosensitive drum, according to certain embodiments of the present disclosure;

FIG. 24 is a partial exploded view of the drum coupling and the photosensitive drum, according to certain embodiments of the present disclosure;

FIG. 25 is a schematic diagram of the structure of the photosensitive drum and drum coupling, according to certain embodiments of the present disclosure;

FIG. 26 is an exploded schematic diagram of the drum coupling and braking member, according to certain embodiments of the present disclosure;

FIG. 27 is a partial cross-sectional view of the drive end of the processing cartridge, according to certain embodiments of the present disclosure;

FIG. 28 is a partial cross-sectional view of the conductive end of the processing cartridge, according to certain embodiments of the present disclosure;

FIG. 29 is a schematic diagram of the structure of the drum coupling from one angle, according to certain embodiments of the present disclosure;

FIG. 30 is a schematic diagram of the structure of the drum coupling from another angle, according to certain embodiments of the present disclosure;

FIG. 31 is a schematic diagram of the structure of the drive force transmission member of the drum drive force transmission unit from another angle;

FIG. 32 is a schematic diagram of the structure of the drum coupling, according to certain embodiments of the present disclosure;

FIG. 33 is a schematic diagram of the structure of the drum coupling from one angle, according to certain embodiments of the present disclosure;

FIG. 34 is a schematic diagram of the structure of the drum coupling from another angle, according to certain embodiments of the present disclosure;

FIG. 35 is a schematic diagram of the structure of the drum coupling, according to certain embodiments of the present disclosure;

FIG. 36 is a schematic diagram of the structure of the drum coupling from one angle, according to certain embodiments of the present disclosure; and

FIG. 37 is a schematic diagram of the structure of the drum coupling from another angle, according to certain embodiments of the present disclosure.

### DETAILED DESCRIPTION

The present disclosure will be further described in detail below with reference to the accompanying drawings. It is evident that the described embodiments are only some embodiments of the present disclosure, and not all of them. All other embodiments obtained by those skilled in the technical field based on certain embodiments of the present disclosure without inventive effort are within the scope of protection of the present disclosure.

The terms “first,” “second,” or the like, are used for descriptive purposes only and should not be necessarily interpreted as indicating or implying relative importance or implicitly stating the number of technical features indicated. Therefore, features qualified with “first,” “second,” or the like, may explicitly or implicitly include at least one of that feature. In the description of this present disclosure, “multiple” means at least two, such as two, three, or the like, unless otherwise explicitly stated.

In the present disclosure, unless otherwise explicitly stated and defined, terms such as “install,” “connect,” and “fix” should be understood broadly. For example, they may refer to a fixed connection, a detachable connection, or an integral connection; a mechanical connection, an electrical connection, or a connection that allows for communication between components; a direct connection or an indirect connection through an intermediate medium; or an internal connection within two components or an interaction between two components, unless otherwise explicitly defined. Those skilled in the technical field may understand the meaning of these terms in the present disclosure based on the context.

In the present disclosure, unless otherwise explicitly stated and defined, the first feature being “on” or “below” the second feature may mean that the first and second features are in direct contact, or that the first and second features are in indirect contact through an intermediate medium. Furthermore, the first feature being “above,” “on top of,” or “over” the second feature may mean that the first feature is directly above or diagonally above the second feature, or simply that the first feature is at a higher horizontal level than the second feature. The first feature being “below,” “beneath,” or “under” the second feature may mean that the first feature is directly below or diagonally below the second feature, or simply that the first feature is at a lower horizontal level than the second feature.

In the above description, references to terms such as “one embodiment,” “some embodiments,” “example,” “specific example,” or “some examples” mean that the particular features, structures, materials, or characteristics described in connection with that embodiment or example are included in at least one embodiment or example of the present disclosure. In the present disclosure, the illustrative descriptions of the aforementioned terms do not necessarily refer to the same embodiment or example. Furthermore, the described features, structures, materials, or characteristics may be combined in any suitable manner in one or more embodiments or examples. In addition, without contradicting each other, those skilled in the technical field may combine and integrate the different embodiments or examples and the features of the different embodiments or examples described in the present disclosure.

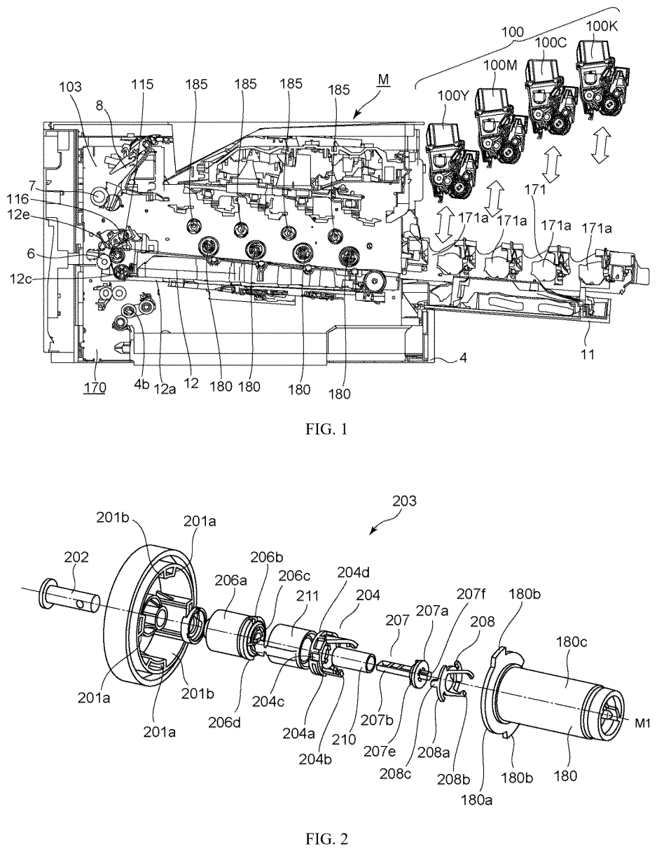

As shown in FIG. 1, there is an electronic imaging device M, which has essentially the same structure and principle as the electronic imaging device M disclosed in patent CN113574469A. The following description of the electronic imaging device M is brief. In the following description, the reference numerals in the figures that are the same as those in patent CN113574469A refer to the same components and have the same structure and working principle.

The electronic imaging device M includes a main assembly 170, a tray 171, and a door cover 11. The main assembly 170 is configured with a housing, a drum drive transmission unit 203, a separation mechanism, and a transfer unit, or the like. The tray 171 may house a processing cartridge 100 and may move relative to the main assembly 170 to accommodate the processing cartridge 100 into the housing of the main assembly 170. The door cover 11 is located on the outside of the main assembly 170 and may open or close the housing of the main assembly 170.

As shown in FIG. 1, the main assembly 170 contains four processing cartridges 100 (100Y, 100M, 100C, and 100K), namely the first processing cartridge 100Y, the second processing cartridge 100M, the third processing cartridge 100C, and the fourth processing cartridge 100K. The four processing cartridges 100 are arranged essentially horizontally. Rotational drive force is provided from the drive output section of the main assembly 170, and the main assembly 170 provides bias voltages (charging bias voltage, developing bias voltage, or the like) to the first to fourth processing cartridges 100 (100Y, 100M, 100C, 100K) respectively. The processing cartridges are accommodated inside the main assembly 170 via a tray 171. The tray is configured to move in a generally horizontal direction when the main assembly 170 is mounted on a horizontal surface, with four processing cartridges accommodated (for example, mounted) to each positioning portion of the tray respectively. When the tray moves into the main assembly 170, the multiple processing cartridges 100 move together with the tray into the main assembly 170. When the processing cartridges need to be replaced, the multiple processing cartridges may be moved together with the tray to the outside of the main assembly 170.

The processing cartridge has a developing coupling (developing drive force receiving section) and a drum coupling (photosensitive component connecting component). Closing the door cover 11 of the main assembly 170 engages the drum drive transmission unit 203 and the developing drive transmission unit on the main assembly side with the processing cartridge to transmit the drive force to the processing cartridge.

When the door cover 11 is opened, the drum drive transmission unit 203 and the developing drive transmission unit retract and disengage from the drum coupling and developing coupling of the processing cartridge 100, allowing the tray 171 and the processing cartridge 100 to be easily removed from the main assembly 170.

As shown in FIGS. 2, 4 and 12, the drum drive transmission unit 203 configured on the main assembly 170, includes a drive force transmission assembly and a braking force applying assembly. The drive force transmission assembly includes a rotating member 201 and a drive force transmission member 180. The rotating member 201 is rotatably supported on a support shaft 202. One end of the drive force transmission member 180 is provided with a rotating stop section 180b for receiving the drive force, and the other end is provided with a drive force transmission portion 180d. The drive force transmission portion 180d consists of protrusions distributed circumferentially on the inner wall of the drive force transmission member 180. The drive force transmission portion 180d has a drive transmission surface 180d1 on one side in the circumference direction, and an abutting surface 180d2 on the other side in the circumference direction, opposite to the drive transmission surface 180d1. The drive force transmission member 180 also includes a reinforcing cylindrical section 180 e to enhance the rigidity of the drive force transmission portion 180d. A positioning protrusion 180i is also provided at the central axis of the drive force transmission member 180.

The drive force transmission member 180 is assembled onto the rotating member 201 in a manner that allows for axial movement along axis M1. The rotation of the rotating member 201 drives the rotation of the drive force transmission member 180 through the engagement between the rotating stop section 201b of the rotating member 201 and the rotating stop section 180b of the drive force transmission member 180. The drive force transmission member 180 may extend along the axial direction M1 towards the processing cartridge to engage with the drum coupling of the processing cartridge, with the direction towards the processing cartridge along the axial direction M1 also referred to as the extension direction M1B; the drive force transmission member 180 may retract along the axial direction M1 away from the processing cartridge to disengage from the drum coupling of the processing cartridge, with the direction away from the processing cartridge along the axial direction M1 also referred to as the retraction direction M1A.

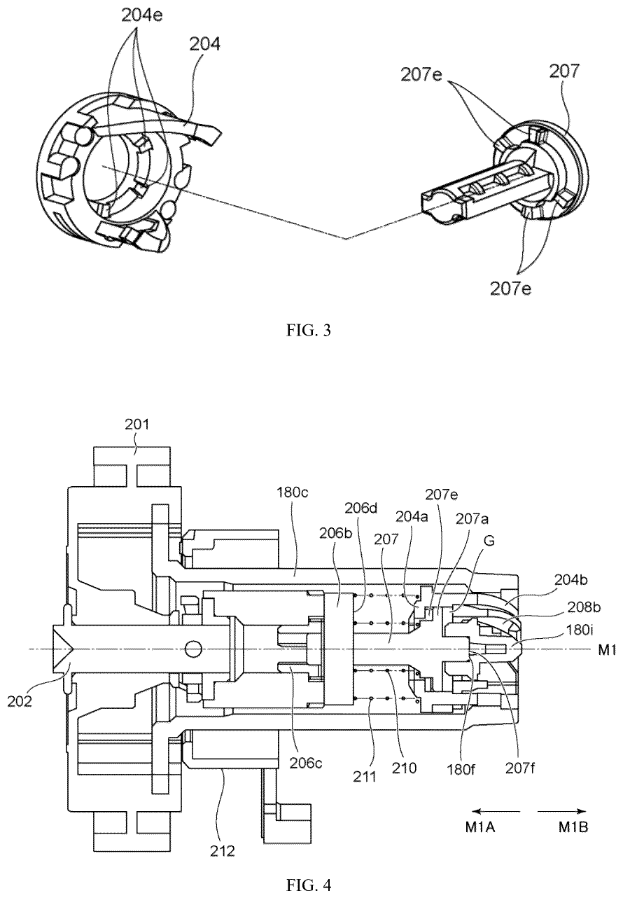

As shown in FIGS. 2 to 5, the braking force applying assembly includes a braking member 206, a first braking force engagement member 204, a second braking force engagement member 208, a first engagement spring 211, a second spring 210, and a braking transmission member 207. The braking member 206 includes a fixed side 206a and a rotating side 206b. The fixed side 206a is fixedly connected to the support shaft 202, and the rotating side 206b may rotate relative to the fixed side 206a and generate a braking force. The method for generating the braking force may be appropriately selected from those methods using friction and viscosity.

The first braking force engagement member 204 and the second braking force engagement member 208 are used to apply braking force to the processing cartridge 100. They may be assembled together by engaging the rotating stop protrusion 208c and the rotating stop recess 204c, allowing for synchronized movement. The second braking force engagement member 208 is located on the inner side of the first braking force engagement member 204, and the engagement section 204b of the first braking force engagement member 204 may be in contact with or abut against the drive force transmission portion 180d.

The shaft section 207b of the braking transmission member 207 passes through the through holes in the middle of the first braking force engagement member 204 and the second braking force engagement member 208, and is connected to the rotating side 206b of the braking member 206, so as to transmit braking force to the first braking force engagement member 204 and the second braking force engagement member 208.

The flange section 207a of the braking transmission member 207 is provided with a protrusion 207e, and correspondingly, the flange section 204a of the first braking force engagement member 204 is provided with a protrusion 204e. When the protrusion 207e of the braking transmission member 207 engages with the protrusion 204e of the first braking force engagement member 204, the braking transmission member 207 may transmit braking force to the first braking force engagement member 204.

The first braking force engagement member 204 and the second braking force engagement member 208 are capable of moving relative to the braking transmission member 207 and the braking member 206 along the axial direction M1. When the protrusion 207e of the braking transmission member 207 and the protrusion 204e of the first braking force engagement member 204 are misaligned or separated along the axial direction M1, the second braking force engagement member 208 and the first braking force engagement member 204 will not receive any braking force.

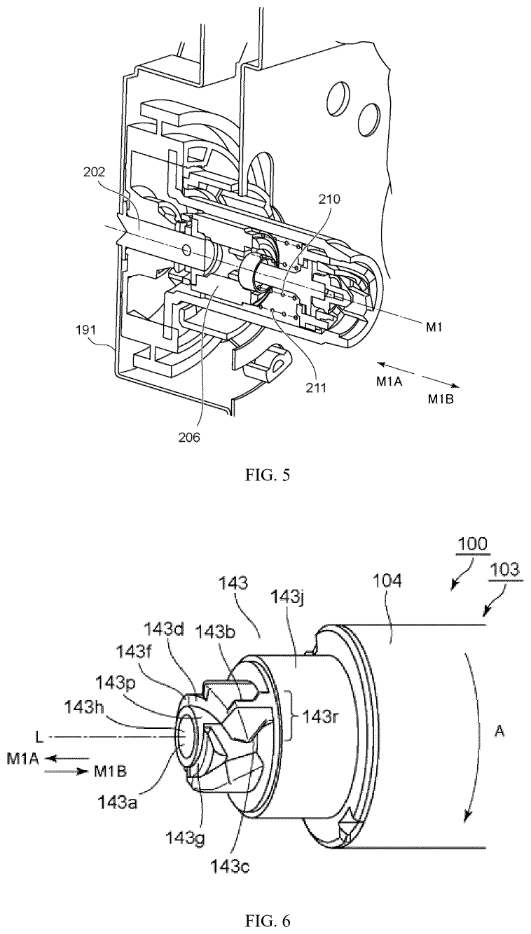

Continuing, with reference to FIGS. 4 and 5, one end of the first engagement spring 211 is pressed against the end surface 206d of the braking member 206, and the other end is pressed against the flange section 204a of the first braking force engagement member 204. The first engagement spring 211 is at a compressed state, applying an elastic force to the first braking force engagement member 204 in the M1B direction. This elastic force helps ensure that the protrusion 207e of the braking transmission member 207 remains engaged with the protrusion 204e of the first braking force engagement member 204.

The second spring 210 is a compression coil spring and is arranged to be sandwiched and compressed between the end surface 206d of the braking member 206 and the flange section 207a of the braking transmission member 207. The second spring 210 applies a repulsive force (pushing force, spring force) to each of the end surface 206d of the braking member 206 and the flange section 207a of the braking transmission member 207.

Regarding drum drive transmission unit 203, under the action of the first engagement spring 211 and the second spring 210, the protrusion 207f at the end of the braking transmission member 207 in the axial direction M1A abuts against the contact surface 108f of the drive force transmission member 180. The movement of the drive force transmission member 180 in the direction of arrow M1B is controlled (limited) by the axial direction limiting section 212, so that the drive force transmission member 180 does not detach from the drum drive transmission unit 203 on the main assembly 170 side.

Regarding the components of the drum drive transmission unit 203, the drive force transmission member 180 is movable relative to the rotating member 201 in the M1A direction (retraction direction) and the M1B direction (extension direction). The first braking force engagement member 204 and the second braking force engagement member 208 are movable relative to the braking transmission member 207 and the rotating member 201 in the M1A direction (retraction direction) and the M1B direction (extension direction), and are also movable relative to the drive force transmission member 180 in the M1A and M1B directions.

As shown in FIGS. 2 to 5, in the existing technology, when the drive force transmission member 180 rotates but the processing cartridge is not engaged with the drive force transmission member 180 (for example, the drive force transmission member 180 is rotating freely), the protrusion on the M1A side of the drive force transmission member 180 presses against the protrusion on the M1B side of the braking transmission member 207. Since both protrusions have tilted surfaces, the braking transmission member 207 moves/retracts towards the inside of the drive force transmission member 180 (moves along the M1A direction). Furthermore, the braking transmission member 207 drives the first braking force engagement member 204 and the second braking force engagement member 208 to move towards the inside of the drive force transmission member 180. When the drive force transmission member 180 rotates until its protrusion passes the protrusion of the braking transmission member 207, the braking transmission member 207, the first braking force engagement member 204, and the second braking force engagement member 208 spring back (move in the M1B direction) under the force of the first engagement spring 211 and the second spring 210, producing an abnormal noise. When the drive force transmission member 180 rotates to the point where the drive transmission surface 180d1 on the drive force transmission portion 180d contacts the first braking force engagement member 204, it causes the first braking force engagement member 204 to rotate, while the braking transmission member 207 does not rotate. When the first braking force engagement member 204 rotates to the point where its protrusion 204e contacts the protrusion 207e of the braking transmission member 207, the first braking force engagement member 204 moves towards the inside of the drive force transmission member 180. After the protrusion 204e of the first braking force engagement member 204 passes the protrusion 207e of the braking transmission member 207, the first braking force engagement member 204 springs back, producing an abnormal noise.

As shown in FIG. 6, in the existing technology, the drum coupling 143 of the processing cartridge 100 is located at one end of the photosensitive drum 104. The drum coupling 143 has a protrusion that extends outward in the axial direction from the surface of the end section of the shaft section 143j. This protrusion has a drive force receiving section 143b as a first side surface (first side section) for receiving drive force from the drive transmission unit 203. Furthermore, the protrusion of the drum coupling 143 includes a braking force receiving section 143c as a second side surface (second side section) for receiving braking force from the drive transmission unit 203. The drive force receiving section 143b is the side surface (side section) facing the upstream side in the rotational direction A of the drum unit. Furthermore, the braking force receiving section 143c is located on the side surface (side section) facing the downstream side in the rotational direction A. The braking force receiving section 143c is a surface tilted relative to the axial direction M1, and along the M1A direction (retraction direction), the braking force receiving section 143c gradually tilts towards the downstream side of the rotational direction A. When the drive force transmission member 180 is engaged with the drum coupling 143, the first braking force engagement member 204 and the second braking force engagement member 208 engage with the braking force receiving section 143c, after which the abnormal noise during the rotation of the drive force transmission member 180 disappears.

### Example 1

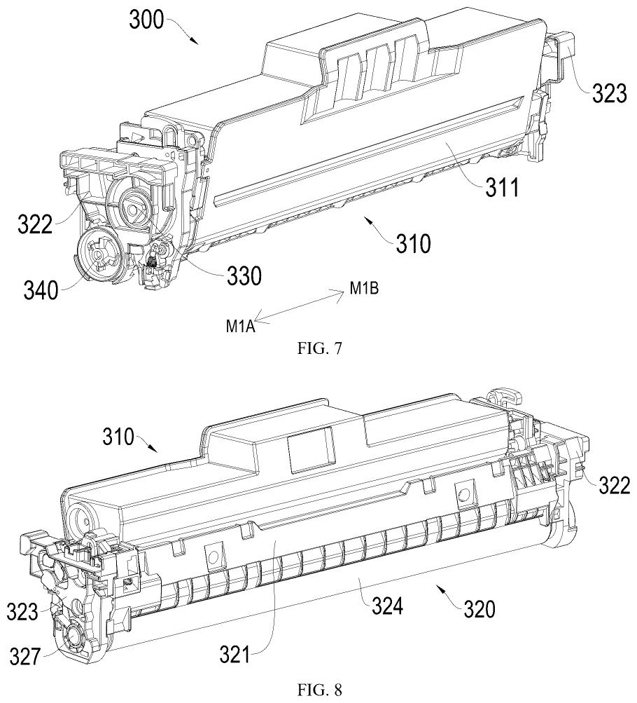

In certain embodiments of the present disclosure, and as shown in FIGS. 7 and 8, provided is a processing cartridge 300 that is detachably accommodated to the main assembly of an electronic imaging device M, including a developing unit 310, a drum unit 320, a drive assembly, and a braking member 350.

The developing unit 310 includes a developing frame 311, a developing roller, a toner supply roller, and a toner doctor blade. The drum unit 320 includes a drum frame 321, a photosensitive drum 324, and a charging roller. The drive assembly includes a developing coupling 330, a drum coupling 340, a developing roller gear, and a toner supply roller gear.

As shown in FIGS. 7 and 8, the developing frame 311 encloses a toner reservoir for storing toner. The developing frame 311 is roughly in the shape of a long box. The developing frame 311 has a drive-side bearing and a conductive-side bearing at each end in the length direction. The toner supply roller and the developing roller are rotatably supported by the drive-side bearing and the conductive-side bearing at both ends of the developing frame 311 in the length direction. The toner supply roller and the developing roller may rotate under the action of the drive assembly, and their axes are both along the length direction of the developing frame 311. The toner supply roller transports the toner to the developing roller, where it is attracted by the charged developing roller.

As shown in FIGS. 7 and 8, the drum frame 321 also has a length direction, which is consistent with the length direction of the developing frame 311. The drum frame 321 includes a drive-side end cap 322 and a conductive-side end cap 323, which are respectively configured at both ends in its length direction. The photosensitive drum 324 is rotatably supported at both ends of the drum frame 321 in the length direction, in particular supported on the drive-side end cap 322 and the conductive-side end cap 323. A drive bearing 325 and a conductive bearing 326 are respectively configured at both axial ends of the photosensitive drum 324. The photosensitive drum 324 is supported by the drive bearing 325 and the conductive bearing 326 in through holes of the drive-side end cap 322 and the conductive-side end cap 323, respectively. The photosensitive drum 324 is configured at the lower end of the drum frame 321 in the height direction. The developing unit 310 and the drum unit 320 are connected to each other via a drive-side end cap 322 and a conductive-side end cap 323. The developing roller and the photosensitive drum 324 are positioned close to each other, and the toner attracted to the developing roller is transferred to the photosensitive drum 324 through the potential difference between them. The charging roller is used to uniformly charge the surface of the photosensitive drum 324, enabling the photosensitive drum 324 to attract toner.

As shown in FIG. 7, the developing coupling 330, the developing roller gear, the toner supply roller gear, and the stirring frame gear are configured at the outer side of the drive-side bearing. In particular, the drive-side bearing has a support hole for supporting the developing coupling 330, and the developing coupling 330 is used to engage with the developing drive transmission unit of the electronic imaging device and receive the drive force. The developing roller gear is mounted on the end of the developing roller shaft extending from the drive-side bearing, and the toner supply roller gear is mounted on the end of the toner supply roller shaft extending from the drive-side bearing. The developing roller gear and the toner supply roller gear engage directly or indirectly with the developing coupling 330 to transmit the drive force received by the developing coupling 330, thereby driving the developing roller and the toner supply roller to rotate.

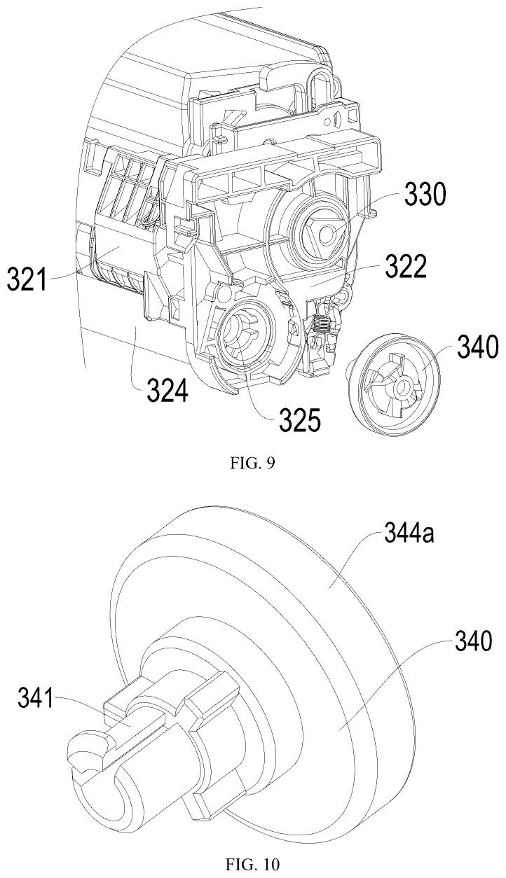

As shown in FIGS. 7 to 11, the drum coupling 340 is positioned at the end of the photosensitive drum 324 in the length (axial) direction. The drum coupling 340 is used to receive the drive force of the electronic imaging device (transmitted through engagement with the drive force transmission member 180) to drive the photosensitive drum 324 to rotate. The axial direction of the drum coupling 340 is consistent with the axial direction M1 of the drive force transmission member 180. The drum coupling 340 includes an accommodating portion 341 (for example, a mounting portion), a drive force receiving portion 342, a compression portion 343, and a limiting portion.

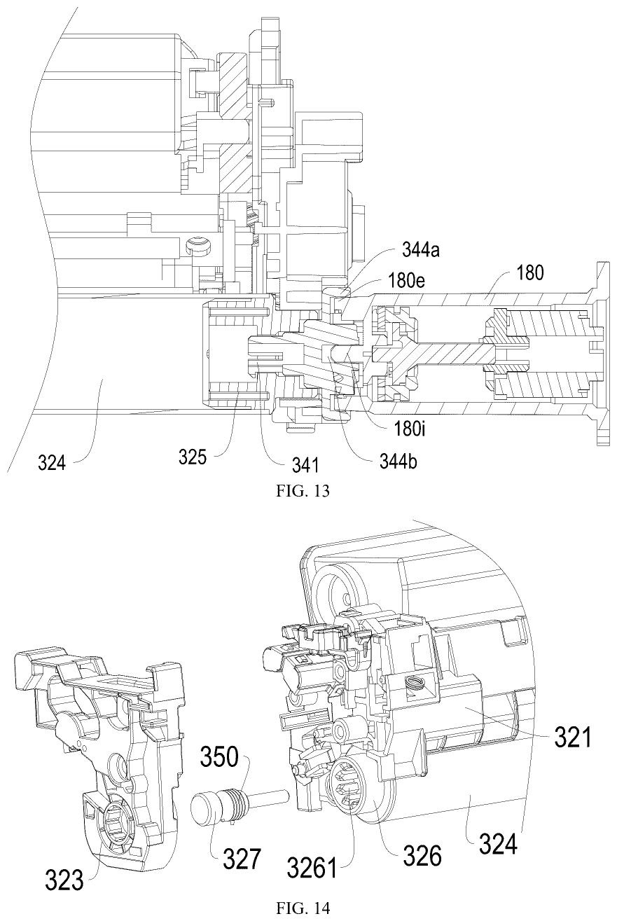

As shown in FIGS. 10 and 13, the accommodating portion 341 is configured at the side of the drum coupling 340 facing the photosensitive drum 324 (for example, the M1B direction side). The accommodating portion 341 is used to connect with the photosensitive drum 324 (for example, with the drive bearing 325 at the drive end of the photosensitive drum 324), thereby fixing the drum coupling 340 to one end of the photosensitive drum 324. During assembly, the accommodating portion 341 is inserted into the drive bearing 325 of the photosensitive drum 324 and may be fixed by methods such as engaging, gluing, or applying adhesive. Furthermore, the accommodating portion 341 is configured with a protrusion that may engage with and position the drive bearing 325 of the photosensitive drum 324.

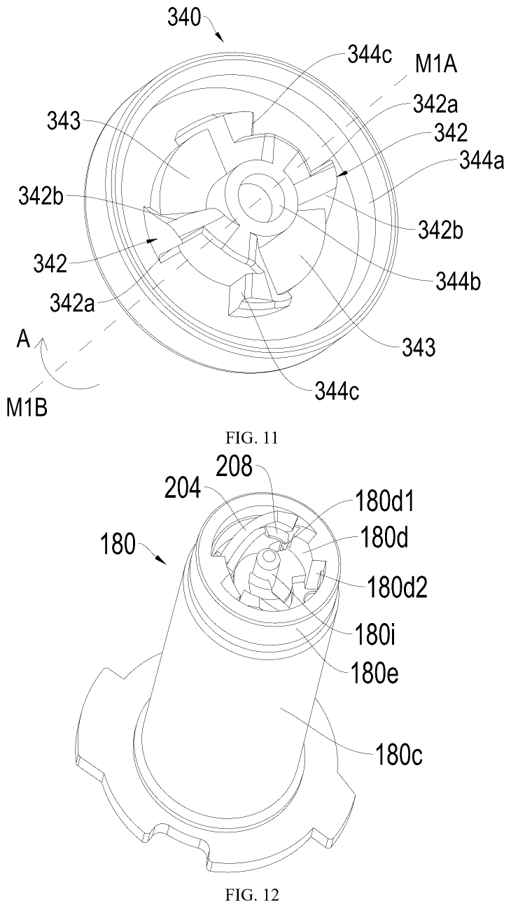

As shown in FIG. 11, the drive force receiving portion 342 is configured at the end surface of the drum coupling 340 facing away from the photosensitive drum 324 (for example, the end surface on the M1A direction side). The drive force receiving portion 342 is a first protrusion extending from the end surface of the drum coupling 340. The drive force receiving portion 342 is used to receive the drive force applied by the drive force transmission portion 180d. There are two drive force receiving portions 342, configured symmetrically on the end surface of the coupling. When the drum coupling 340 is engaged with the drive force transmitting member 180, one side of the drive force receiving portion 342 (the side on the upstream side in the rotational direction A) serves as the drive force receiving surface 342a. The drive force receiving surface 342a abuts against the drive transmission surface 180d1 of the drive force transmission portion 180d to receive the drive force. The other side of the drive force receiving portion 342 is the braking force receiving surface 342b, which is positioned opposite to the drive force receiving surface 342a. The braking force receiving surface 342b is the surface of the drive force receiving portion 342 on the downstream side in the rotational direction A, and the braking force receiving surface 342b is a surface tilted relative to the axial direction M1. Along the M1A direction (retraction direction), the braking force receiving surface 342b gradually tilts towards the upstream side of the rotational direction A. That is, the tilting direction of the braking force receiving surface 342b is opposite to the tilting direction of the braking force receiving section 143c in the existing technology. Therefore, the braking force receiving surface 342b may not engage with the first braking force engagement member 204/second braking force engagement member 208, and thus may not solve the problem of abnormal noise generated during the rotation of the drive force transmission member 180 through their engagement.

Based on this, certain embodiments provide a solution to address the aforementioned abnormal noise problem. As shown in FIG. 11, the drum coupling 340 includes a compression portion 343. The compression portion 343 is configured at the end surface of the drum coupling 340 facing away from the photosensitive drum 324 (the end surface on the M1A direction side). The compression portion 343 is a second protrusion extending from the end surface of the drum coupling 340. The compression portion 343 is connected to the drive force receiving portion 342 and is configured at the downstream side of the drive force receiving portion 342 in the rotation direction A, for example, the compression portion 343 is connected to the side of the drive force receiving portion 342 where the braking force receiving surface 342b is located. The compression portion 343 acts on the braking force applying assembly and is used to reduce or eliminate abnormal noise during the rotation of the drive force transmission member. There are two second protrusions, and the two compression portions 343 are spaced apart in the circumference direction (rotation direction A), and the two compression portions 343 are configured in a symmetrical manner. The compression portion 343 protrudes axially from the end surface to a certain height, but the height of the compression portion 343 protruding from the end surface is lower than the height of the drive force receiving portion 342 protruding from the end surface. When the drive force transmission member 180 moves towards the processing cartridge 300 (in the M1B direction/extension direction), the second braking force engagement member 208 comes into contact with the compression portion 343 and is subjected to pressure from the compression portion 343 during the relative movement. The second braking force engagement member 208 moves inward/retracts towards the drive force transmission member 180 (moves in the M1A direction). At this time, the first braking force engagement member 204 is integrally pressed to move inward/retract towards the drive force transmission member 180. Subsequently, the braking transmission member 207, under the action of the second braking force engagement member 208, also moves towards the inside of the drive force transmission member 180, away from the processing cartridge 300, causing the protrusion 204e on the first braking force engagement member 204 to become misaligned with the protrusion 207e of the braking transmission member 207, thereby reducing or eliminating abnormal noise. Furthermore, when the height of the compression portion 343 extending from the end surface is sufficient, the first braking force engagement member 204 and the second braking force engagement member 208 may move a greater distance in the M1A direction (retraction direction). In this situation, the second braking force engagement member 208 may also drive the braking transmission member 207 to move inward towards the drive force transmission member 180 (moving in the M1A direction), thereby reducing or eliminating the abnormal noise generated between the braking transmission member 207 and the drive force transmission member 180.

In certain embodiments, the number of compression portions 343 may be set to be more or less, such as one, three, four, or the like.

As shown in FIG. 11, the limiting portion is used to limit or prevent relative tilting when the drum drive transmission unit engages with the drum coupling 340. The limiting portion includes a first limiting portion 344a, a second limiting portion 344b, and a third limiting portion 344c.

As shown in FIGS. 11 to 13, the first limiting portion 344a is a first annular protrusion configured at the outer circumference of the drum coupling 340. The first annular protrusion protrudes in the M1A direction (retraction direction), and its inner diameter is sized to fit the drive force transmission member 180 of the electronic imaging device. When the drive force transmission member 180 extends in the M1B direction and engages with the drum coupling 340, the cylindrical section 180e of the drive force transmission member 180 extends into and contacts the first annular protrusion. In particular, the first annular protrusion encloses a section of the drive force transmission member 180, which limits the movement of the drive force transmission member 180 and prevents it from tilting relative to the drum coupling 340, thus preventing printing defects. Furthermore, the end of the first annular protrusion away from the photosensitive drum 324 is configured with a guiding surface, which is a tilted surface. This guiding surface facilitates the engagement of the drive force transmission member 180 and the drum coupling 340, making the engagement smoother and reducing the engagement time.

As shown in FIGS. 11 to 13, the second limiting portion 344b is a second annular protrusion configured at the central axis of the drum coupling 340. The second annular protrusion protrudes from the end surface of the drum coupling 340 in the M1A direction and is located at the central axis of the drum coupling 340. The inner diameter of the second annular protrusion fits the positioning protrusion 180i of the drive force transmission member 180. When the drive force transmission member 180 extends in the direction of M1B and engages with the drum coupling 340, a section of the positioning protrusion 180i extends into and contacts the second annular protrusion, thereby limiting the movement of the drive force transmission member 180. The drive force receiving portion 342 and the compression portion 343 are distributed around the periphery of the second limiting portion 344b.

As shown in FIG. 11, the third limiting portion 344c is an abutting protrusion configured at the end surface of the drum coupling 340. There are two third limiting portions 344c, which are configured centrally symmetrically on the end surface of the drum coupling 340. The third limiting portions 344c are located at the periphery of the second limiting portion 344b. Along the circumference of the drum coupling 340, the drive force receiving portion 342, the third limiting portion 344c, and the compression portion 343 are arranged in sequence. The drive force receiving portion 342 and the third limiting portion 344c (abutting protrusion) have a certain interval in the circumference direction. This interval fits the circumference width of the drive force transmission portion 180d of the drive force transmission member 180. The surface of the third limiting portion 344c facing the drive force receiving portion 342 serves as the abutting surface. When the drive force transmission member 180 extends in the direction of M1B and engages with the drum coupling 340, the drive force transmission portion 180d is fully or partially inserted into the interval between the third limiting portion 344c and the drive force receiving portion 342. The drive transmission surface 180d1 of the drive force transmission portion 180d abuts against the side of the drive force receiving portion 342 facing the third limiting portion 344c (for example, the drive force receiving surface 342a) to receive the drive force. The abutting surface 180d2 of the drive force transmission portion 180d abuts against the abutting surface of the third limiting portion 344c, so that the drive force transmission member 180 is limited by the third limiting portion 344c, preventing tilting between the two.

In certain embodiments, the drum coupling 340 is configured with multiple limiting portions to limit the drive force transmission member 180, preventing tilting or misalignment when the drum coupling 340 engages with the drive force transmission member 180. This helps ensure stable contact between the drum coupling 340 and the drive force transmission member 180, avoiding poor printing quality.

Due to the tilting direction of the braking force receiving surface 342b of the drum coupling 340 in certain embodiments and the action of the compression portion 343, it may not engage with the first braking force engagement member 204 and the second braking force engagement member 208, and therefore may not receive sufficient braking force from the electronic imaging device side. Therefore, a braking member 350 is added to the processing cartridge 300 to provide braking force to the photosensitive drum 324, helping ensure stable rotation of the photosensitive drum 324.

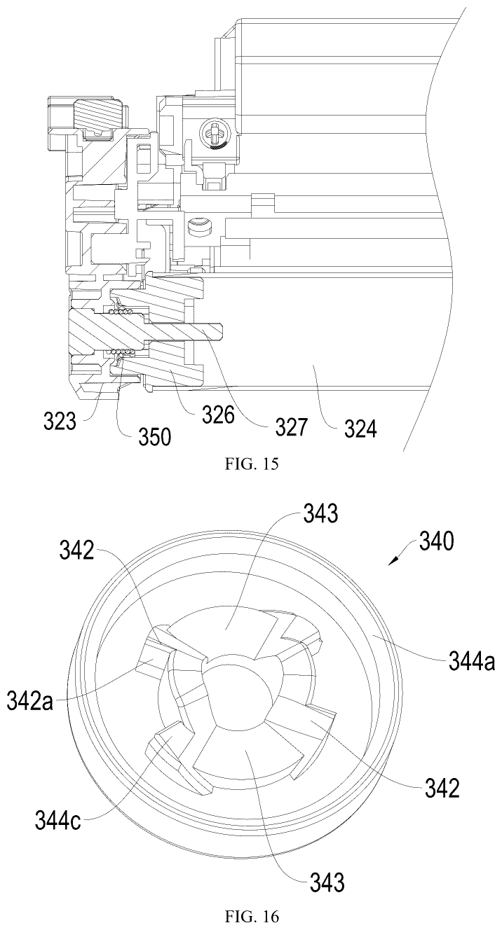

As shown in FIGS. 14 and 15, in certain embodiments, the braking member 350 is configured at the conductive end of the processing cartridge 300. In particular, the braking member 350 interacts with the conductive bearing 326 to generate a braking force on the photosensitive drum 324. The conductive bearing 326 is hollow inside, and multiple ribs 3261 are configured at the inner circumference wall of the conductive bearing 326. The processing cartridge 300 includes a conductive shaft pin 327. The conductive shaft pin 327 partially passes through a through hole in the conductive side end cap 323 and is inserted into the conductive bearing 326. The braking member 350 is a torsion spring. The coil of the torsion spring is mounted to the conductive shaft pin 327 and grips it tightly, and is inserted into the conductive bearing 326 along with the conductive shaft pin 327. The arms of the torsion spring abut against the ribs 3261 of the conductive bearing 326 or the interval between two adjacent ribs 3261. The torsion force of the torsion spring acts on the conductive bearing 326, and subsequently on the photosensitive drum 324, thereby generating a braking force on the photosensitive drum 324, helping ensure stable rotation of the photosensitive drum 324.

In certain embodiments, a braking member 350 is configured on the processing cartridge 300 to provide braking force, helping ensure that the photosensitive drum 324 does not rotate when the electronic imaging device is just started. This allows for easier and faster stable engagement with the drum drive transmission unit and stable rotation. Furthermore, the drum coupling 340 is configured with a compression portion 343 that interacts with the braking force applying assembly, reducing or eliminating the problem of abnormal noise during the rotation of the drive force transmission member 180.

### Example 2

This example provides a processing cartridge 300, which differs from Example 1 in that the structure of the drum coupling 340 is different.

As shown in FIG. 16, in certain embodiments, the drum coupling 340 includes an accommodating portion (for example, mounting portion), a drive force receiving portion 342, a compression portion 343, and a limiting portion, where the structures of the accommodating portion, the drive force receiving portion 342, and the compression portion 343 are the same as those in Example 1.

As shown in FIG. 16, the limiting portion includes a first limiting portion 344a and a third limiting portion 344c, while the second limiting portion 344b is omitted. For example, the second annular protrusion located at the central axis of the drum coupling 340 is omitted, forming a recess at the central axis of the drum coupling 340. The positioning protrusion 180i of the drive force transmission member 180 may be inserted into this recess, but the recess does not limit the movement of the positioning protrusion 180i. The structures of the first limiting portion 344a and the third limiting portion 344 c are the same as in Example 1. When the drive force transmission member 180 extends in the M1B direction and engages with the drum coupling 340, the cylindrical section 180e of the drive force transmission member 180 extends into and contacts the first annular protrusion. In certain embodiments, the drive force transmission portion 180d is inserted into the interval between the third limiting portion 344c and the drive force receiving portion 342. In certain embodiments, the drive force transmission surface 180d1 of the drive force transmission part 180d abuts against the side surface (drive force receiving surface 342a) of the drive force receiving portion 342 facing the third limiting portion 344c to receive the drive force. The abutting surface 180d2 of the drive force transmission portion 180d abuts against the abutting surface of the third limiting portion 344c. The drive force transmission member 180 is jointly constrained by the first limiting portion 344a and the third limiting portion 344c, preventing tilting/skewing and helping ensure stable contact.

The other structures of the processing cartridge 300 in this example are the same as those in Example 1, and relevant description is not repeated here for brevity.

### Example 3

This example provides a processing cartridge 300, which differs from Examples 1 and 2 in that the structure of the drum coupling 340 is different.

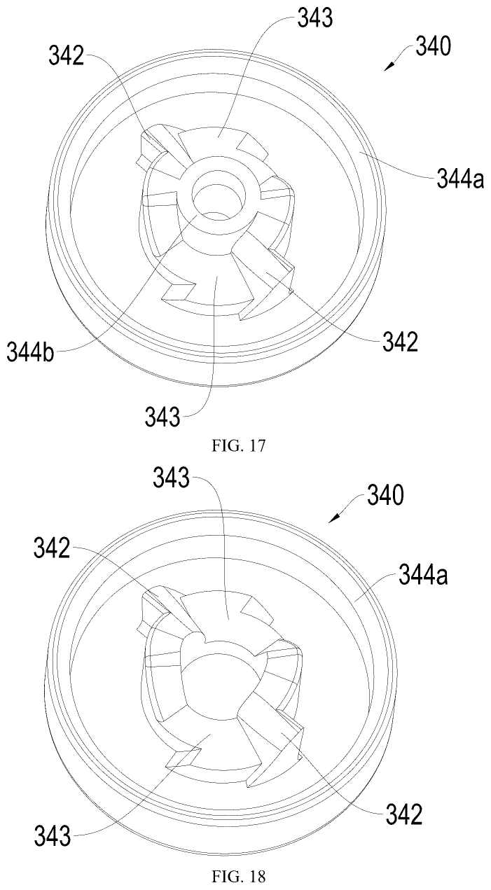

As shown in FIG. 17, in certain embodiments, the structure of the accommodating portion (or a mounting portion), the drive force receiving portion 342, and the compression portion 343 of the drum coupling 340 are the same as in Example 1, but the structure of the limiting portion is different.

As shown in FIG. 17, in certain embodiments, the limiting portion includes a first limiting portion 344a and a second limiting portion 344b, while the third limiting portion 344c is omitted. The structures of the first limiting portion 344a and the second limiting portion 344b are the same as in Example 1. When the drive force transmission member 180 extends in the M1B direction and engages with the drum coupling 340, the cylindrical section 180e of the drive force transmission member 180 extends into and contacts the first annular protrusion (first limiting portion 344a). In particular, the first annular protrusion encloses a section of the drive force transmission member 180, and a section of the positioning protrusion 180i extends into and abuts against the second annular protrusion (second limiting portion 344b). The drive force transmission member 180 is jointly constrained by the first limiting portion 344a and the second limiting portion 344b, preventing tilting/skewing and helping ensure stable contact.

The other structures of the processing cartridge 300 in this example are the same as those in Example 1, and relevant description is not repeated here for brevity.

### Example 4

This example provides a processing cartridge 300, which differs from Examples 1 through 3 in that the structure of the drum coupling 340 is different.

As shown in FIG. 18, in certain embodiments, the structure of the accommodating portion (for example, a mounting portion), the drive force receiving portion 342, and the compression portion 343 of the drum coupling 340 are the same as in Example 1, but the structure of the limiting portion is different.

As shown in FIG. 18, in certain embodiments, the limiting portion only includes the first limiting portion 344a (first annular protrusion), omitting the second limiting portion 344b and the third limiting portion 344c. When the drive force transmission member 180 extends in the M1B direction and engages with the drum coupling 340, the cylindrical section 180e of the drive force transmission member 180 extends into and fits against the first annular protrusion. That is, the first annular protrusion encloses a section of the drive force transmission member 180, which may limit the movement of the drive force transmission member 180 and prevent it from tilting relative to the drum coupling 340, thus avoiding printing defects.

The other structures of the processing cartridge 300 in this example are the same as those in Example 1, and relevant description is not repeated here for brevity.

### Example 5

This example provides a processing cartridge 300, which differs from Example 1 in that the structure of the braking member 350 is different.

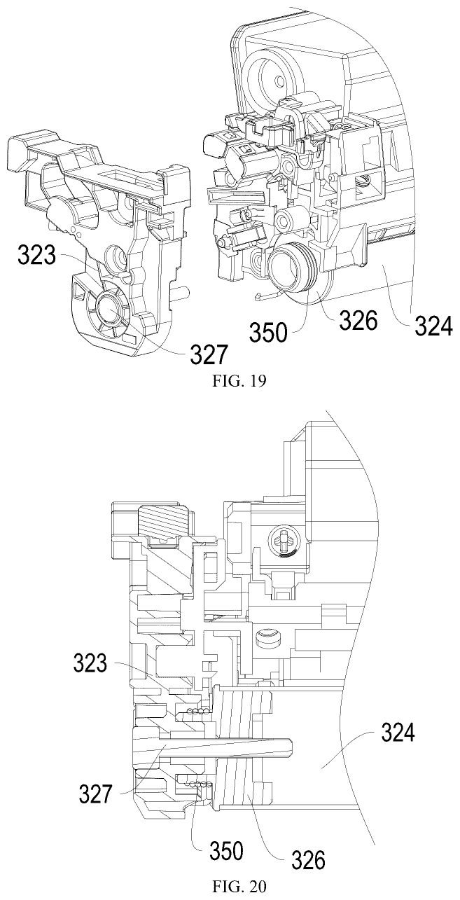

As shown in FIGS. 19 and 20, in certain embodiments, the braking member 350 is a torsion spring. The coil portion of the torsion spring is fitted onto (for example, sleeved on) the outer circumference surface of the cylindrical portion of the conductive bearing 326 and tightly grips the conductive bearing 326. The arms of the torsion spring abut against the conductive side end cap 323. The torsion spring is press-fitted onto the conductive bearing 326, and the arms of the torsion spring are engaged and fixed to the conductive side end cap 323. When the photosensitive drum 324 rotates (the conductive bearing 326 rotates synchronously), the torsion spring does not rotate with it. The torsion force of the torsion spring acts on the conductive bearing 326, and subsequently on the photosensitive drum 324, thereby generating a braking force on the photosensitive drum 324, helping ensure stable rotation of the photosensitive drum 324.

The other structures of the processing cartridge 300 in this example are the same as those in Example 1, and relevant description is not repeated here for brevity.

### Example 6

This example provides a processing cartridge 300, which differs from Examples 1 and 5 in that the structure of the braking member 350 is different.

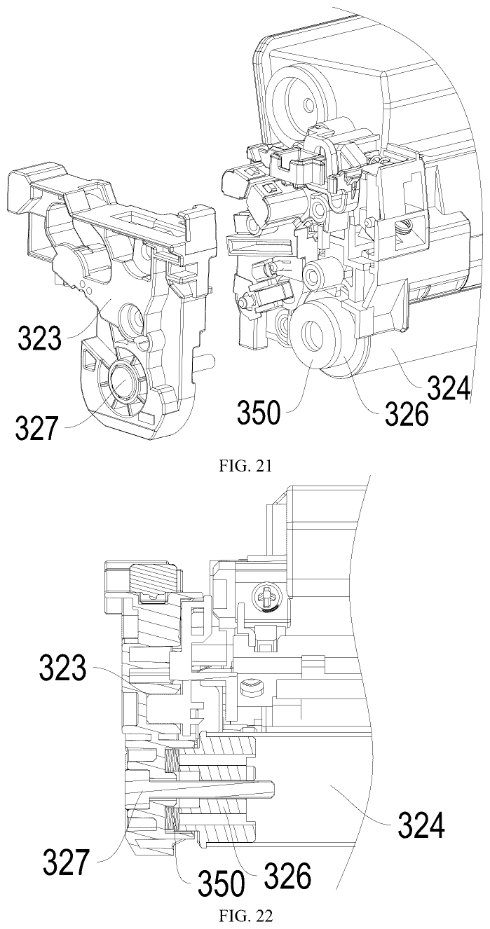

As shown in FIGS. 21 and 22, in certain embodiments, the braking member 350 is an annular member. The braking member 350 is fixedly configured at the end surface of the conductive bearing 326 facing the conductive end cap 323 (the end surface in the direction of M1B), the braking member 350 may be a compressible rubber ring/gasket. The braking member 350 is located between the conductive bearing 326 and the conductive end cap 323. The braking member 350 is compressed and deformed, thereby generating friction between the conductive end cap 323 and the conductive bearing 326. This friction provides a braking force acting on the photosensitive drum 324, allowing the photosensitive drum 324 to rotate stably.

The other structures of the processing cartridge 300 in this example are the same as those in Example 1, and relevant description is not repeated here for brevity.

### Example 7

This example provides a processing cartridge 300, which differs from Example 1 in that the structure of the drum coupling 340 and the structure of the braking member 350 are different.

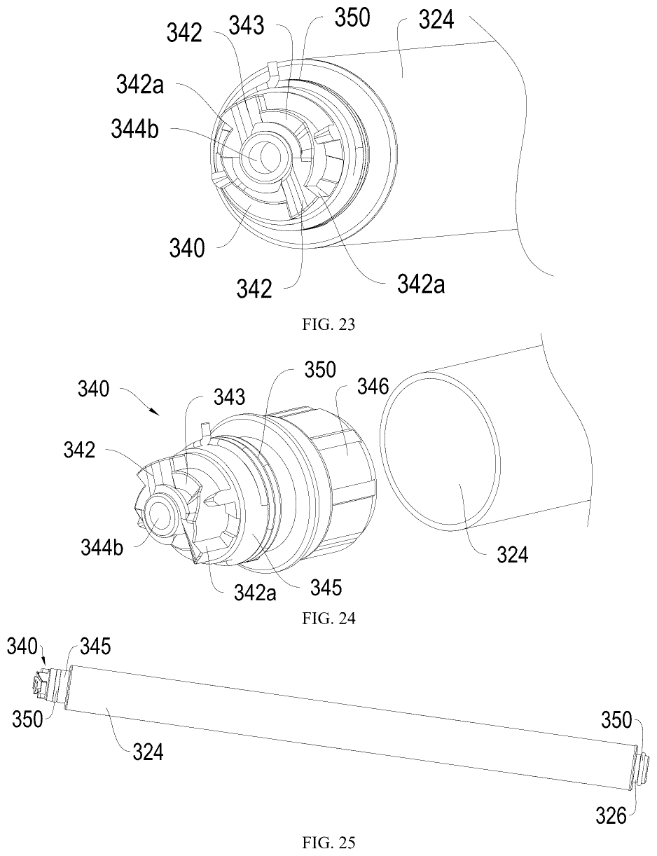

As shown in FIGS. 23 and 24, in certain embodiments, the drum coupling 340 includes a cylindrical portion 345 and a drum connecting portion 346, which are configured sequentially along the M1B direction. The drive end of the photosensitive drum 324 does not have a drive bearing 325; the drum coupling 340 is directly inserted into one end of the photosensitive drum 324 through the drum connecting portion 346 to engage with the photosensitive drum 324. The end surface of the cylindrical portion 345 facing the M1A direction is configured with a drive force receiving portion 342 and a compression portion 343. The structure of the drive force receiving portion 342 (first protrusion) and the compression portion 343 (second protrusion) in this example is the same as in Example 1.

As shown in FIGS. 23 and 24, the limiting portion in this example only includes the second limiting portion 344b (second annular protrusion), omitting the first limiting portion 344a and the third limiting portion 344c.

As shown in FIGS. 23 and 24, in certain embodiments, the braking member 350 is a torsion spring. The coil portion of the torsion spring is fitted onto (for example, sleeved on) the cylindrical portion 345 of the drum coupling 340 and tightly grips the cylindrical portion 345. The torsion spring is press-fitted onto the drum coupling 340. The arms of the torsion spring are engaged and fixed/abutted against the drive-side end cap 322. When the drum coupling 340 drives the photosensitive drum 324 to rotate, the torsion spring does not rotate with it. The torsion force of the torsion spring acts on the drum coupling 340, and subsequently on the photosensitive drum 324, thereby generating a braking force on the photosensitive drum 324, helping ensure stable rotation of the photosensitive drum 324.

The other structures of the processing cartridge 300 in this example are the same as those in Example 1, and relevant description is not repeated here for brevity.

### Example 8

This example provides a processing cartridge 300, which differs from Example 7 in the structure of the braking member 350.

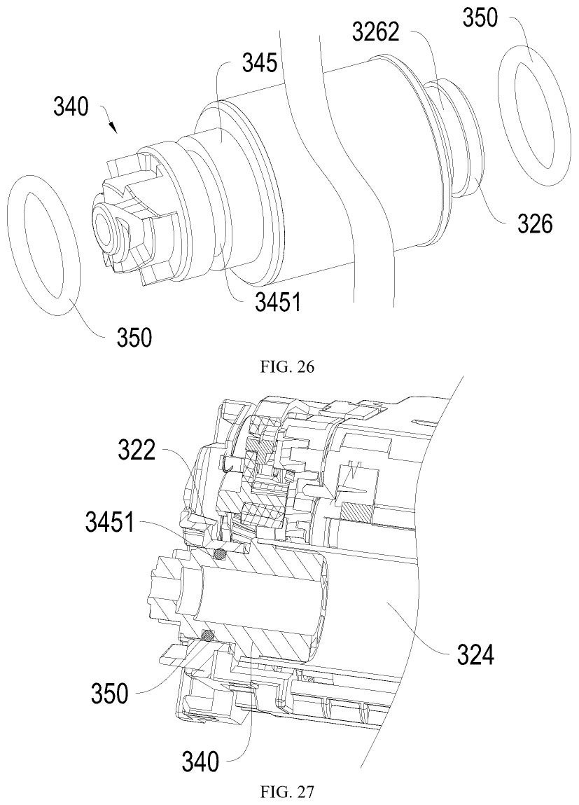

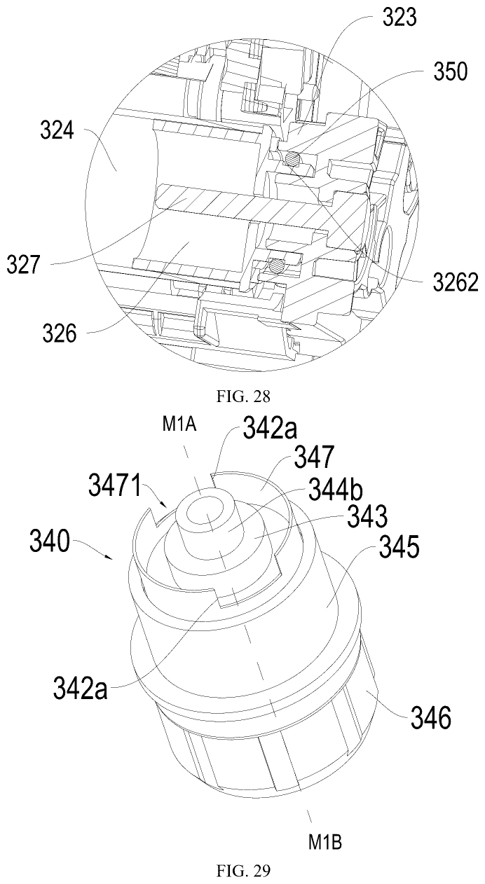

As shown in FIGS. 25 to 28, the braking member 350 in this example is a rubber ring or gasket. The cylindrical portion 345 of the drum coupling 340 has an annular groove 3451 on its circumference surface. The braking member 350 is accommodated within the annular groove 3451, with a section of the braking member 350 protruding from the outer circumference of the cylindrical portion 345. When the drum coupling 340 is supported within the through hole of the drive-side end cap 322, the protruding section of the braking member 350 contacts and is compressed by the drive-side end cap 322, thereby generating friction between the drive-side end cap 322 and the drum coupling 340. This friction provides a braking force acting on the photosensitive drum 324, helping ensure stable rotation of the photosensitive drum 324.

Furthermore, as shown in FIGS. 25 to 28, the braking member 350 may be positioned at the conductive end. In particular, an annular groove 3262 is configured at the outer circumference surface of the cylindrical portion of the conductive bearing 326 at the conductive end of the photosensitive drum 324. The braking member 350 is a rubber ring or rubber gasket, which is fitted into the annular groove 3262 of the conductive bearing 326 and is in contact with and compressed by the conductive end cap 323. The friction between them provides the braking force applied to the photosensitive drum 324.

The other structures of the processing cartridge 300 in this example are the same as those in Example 1, and relevant description is not repeated here for brevity.

### Example 9

This example provides a processing cartridge 300, which differs from Examples 1 through 8 in the structure of the drum coupling 340.

As shown in FIGS. 29 to 31, in certain embodiments, the drum coupling 340 includes a cylindrical portion 345 and a drum connecting portion 346. The end surface of the cylindrical portion 345 facing the M1A direction is configured with a third annular protrusion 347, a compression portion 343, and a limiting portion. The third annular protrusion 347 protrudes in the M1A direction (retraction direction), and the diameter of the third annular protrusion 347 is smaller than the diameter of the cylindrical portion 345, meaning there is a certain distance between the outer circumference surface of the third annular protrusion 347 and the outer circumference surface of the cylindrical portion 345. The third annular protrusion 347 is configured with two symmetrical notches 3471. These notches 3471 allow the drive force transmission portion 180d of the drive force transmission member 180 to be inserted. One side surface of each notch 3471 in the circumference direction serves as a drive force receiving surface 342a. When the drive force transmission member 180 engages with the drum coupling 340, the drive force receiving surface 342a abuts against the drive transmission surface 180d1. In certain embodiments, the third annular protrusion 347 has a smaller radial thickness, and compared to certain embodiments, the area of the drive force receiving surface 342a is smaller. The thickness of the third annular protrusion 347 fits the interval 209 between the first braking force engagement member 204 and the second braking force engagement member 208. In particular, when the drive force transmission member 180 moves in the M1B direction (extension direction), the third annular protrusion 347 is inserted into the interval 209 between the first braking force engagement member 204 and the second braking force engagement member 208. The position of the notch 3471 corresponds to the position of the drive force transmission portion 180d, allowing the drive force transmission portion 180d to be inserted, and the drive force receiving surface 342a abuts against the drive transmission surface 180d1.

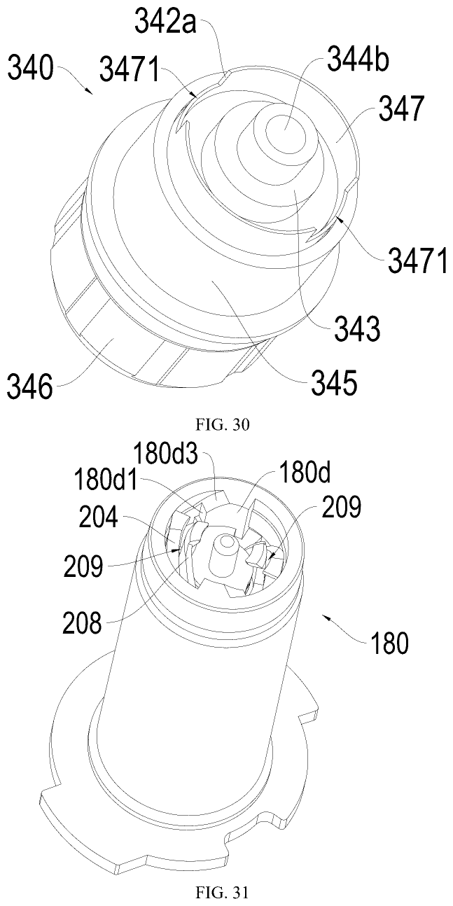

Furthermore, as shown in FIGS. 29 and 30, the compression portion 343 is a frustoconical structure formed at the central axis of the cylindrical portion 345. The frustoconical structure protrudes from the end surface of the cylindrical portion 345 and is located within the inner circumference of the third annular protrusion 347, with a gap between them. The height of the frustoconical structure protruding from the end surface of the cylindrical portion 345 is less than the height of the third annular protrusion 347. When the drive force transmission member 180 moves towards the processing cartridge 300 (in the M1B direction), the second braking force engagement member 208 abuts against the end surface of the frustoconical structure (compression portion 343) and is subjected to compressive force from the frustoconical structure during relative movement. The second braking force engagement member 208 moves towards the inside of the drive force transmission member 180 (in the M1A direction), at which point the first braking force engagement member 204 is integrally pressed and moves towards the inside of the drive force transmission member 180. Next, the braking transmission member 207, under the action of the second braking force engagement member 208, also moves towards the inside of the drive force transmission member 180, away from the processing cartridge 300. At this time, the braking transmission member 207, the first braking force engagement member 204, and the second braking force engagement member 208 disengage from the braking work position, thereby reducing or eliminating the abnormal noise generated when the drive force transmission member 180 rotates.

In certain embodiments, the limiting portion only includes the second limiting portion 344b, which is a second annular protrusion configured at the central axis of the cylindrical portion 345. This second annular protrusion is located within the inner circumference of the frustoconical structure (compression portion 343), and the height of the second limiting portion 344b is greater than the height of the compression portion 343.

The other structures of the processing cartridge 300 in this example are the same as those in Example 1, and relevant description is not repeated here for brevity.

### Example 10

This example provides a processing cartridge 300, which differs from Example 9 in the structure of the drum coupling 340.

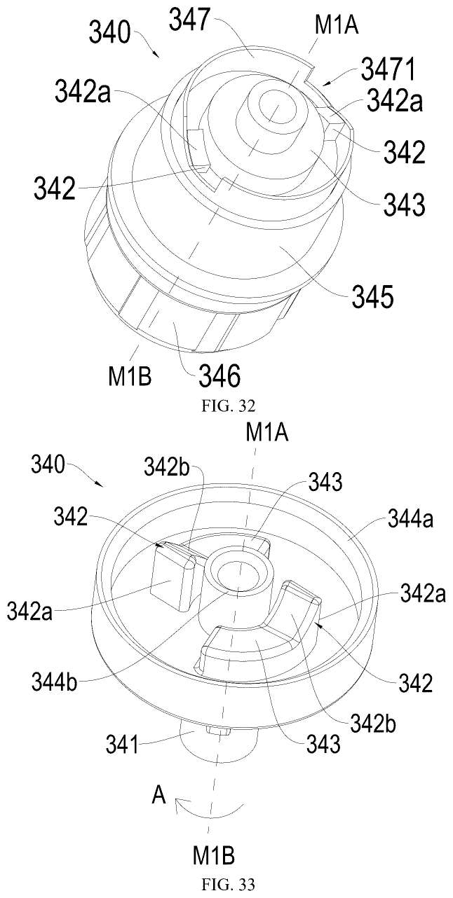

As shown in FIG. 32, in certain embodiments, the drum coupling 340 includes a cylindrical portion 345 and a drum connecting portion 346. The end surface of the cylindrical portion 345 facing the M1A direction is configured with a third annular protrusion 347, a compression portion 343, a limiting portion, and a drive force receiving portion 342.

As shown in FIG. 32, the structure of the third annular protrusion 347, the compression portion 343, and the limiting portion is the same as in Example 9. The drive force receiving portion 342 is a protruding structure, including two protrusions, which are configured symmetrically on the inner wall of the third annular protrusion 347. The position of each protrusion corresponds to the position of a notch 3471 on the third annular protrusion 347. The end surface of the protrusion facing the M1A direction (retraction direction) is the drive force receiving surface 342a, and the drive force receiving surface 342a is a tilted surface relative to the end surface of the cylindrical portion 345. The drive force receiving surface 342a is flush with the surface of the notch 3471 facing the M1A direction.

As shown in FIGS. 31 and 32, the drive force transmission portion 180d is configured with a transmission tilted surface 180d3, one end of which is connected to the drive transmission surface 180d1. When the drive force transmission member 180 extends in the M1B direction and engages with the drum coupling 340, the compression portion 343 pushes the braking force applying assembly to move in the M1A direction to reduce or eliminate abnormal noise generated when the drive force transmission member 180 rotates. The third annular protrusion 347 is inserted into the interval 209 between the first braking force engagement component 204 and the second braking force engagement member 208. The braking force transmission portion 180d is at least partially inserted into the notch 3471 of the third annular protrusion 347, and the transmission tilted surface 180d3 abuts against the drive force receiving surface 342a of the drive force receiving portion 342 to receive the drive force.

The other structures of the processing cartridge 300 in this example are the same as those in Example 1, and relevant description is not repeated here for brevity.

### Example 11

This example provides a processing cartridge, which differs from the previous examples in the structure of the drum coupling 340.

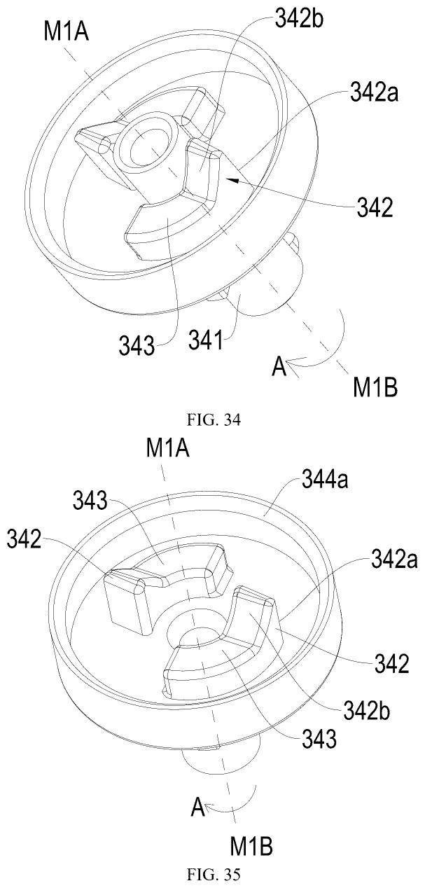

As shown in FIGS. 33 and 34, in certain embodiments, the drum coupling 340 includes an accommodating portion 341, a drive force receiving portion 342, a compression portion 343, and a limiting portion. The structure of the accommodating portion 341 is the same as in Example 1. The limiting portion includes a first limiting portion 344a and a second limiting portion 344b, and the structures of the first limiting portion 344a and the second limiting portion 344b are the same as in Example 1.

As shown in FIGS. 33 and 34, the drive force receiving portion 342 is a first protrusion extending from the end surface of the drum coupling 340. One side of the drive force receiving portion 342 is the drive force receiving surface 342a, which abuts against the drive force transmission surface 180d1 of the drive force transmission portion 180d to receive the drive force. Another side of the drive force receiving portion 342 is the braking force receiving surface 342b. The braking force receiving surface 342b is configured opposite to the drive force receiving surface 342a. The braking force receiving surface 342b is a surface titled relative to the axial direction M1. Along the M1A direction, the braking force receiving surface 342b gradually tilts towards the upstream side of the rotation direction A. That is, the tilting direction of the braking force receiving surface 342b is opposite to the tilting direction of the braking force receiving section 143c in the existing technology.

The compression portion 343 is a second protrusion extending from the end surface of the drum coupling 340. The compression portion 343 is connected to the drive force receiving portion 342 and is located on the downstream side of the drive force receiving portion 342 in the rotation direction A. In particular, the compression portion 343 is connected to the side of the drive force receiving portion 342 where the braking force receiving surface 342b is located. One end of the braking force receiving surface 342b in the M1B direction (extending direction) is connected to one end of the compression portion 343 in the M1A direction (retracting direction). The compression portion 343 acts on the braking force applying assembly to reduce or eliminate abnormal noise during the rotation of the drive force transmission member.

As shown in FIGS. 33 and 34, in certain embodiments, there are two drive force receiving portions 342 and two compression portions 343. One drive force receiving portion 342 and one compression portion 343 form a set of protrusions. The drive force receiving portion 342 and the compression portion 343 in the same set of protrusions are interconnected. The two sets of protrusions are configured symmetrically with respect to the center, and the two sets of protrusions do not contact each other, meaning that there is a certain interval between the upstream and downstream sides of the two sets of protrusions in the rotation direction A.

In certain embodiments, an interval may be formed between the outer wall of the second limiting portion 344b and the compression portion 343 and the drive force receiving portion 342. In certain embodiments, the outer wall of the second limiting portion 344b may be in contact with the compression portion 343 and the drive force receiving portion 342.

### Example 12

As shown in FIG. 35, this example provides a processing cartridge. Compared with Example 11, the difference lies in the structure of the limiting portion of the drum coupling 340. In this example, the limiting portion only includes the first limiting portion 344a. The other structures of the drum coupling 340 are the same as those in Example 11, and relevant description is not repeated here for brevity.

### Example 13

This example provides a processing cartridge, which differs from Example 11 in that the structure of the drive force receiving portion 342 of the drum coupling 340 is different.

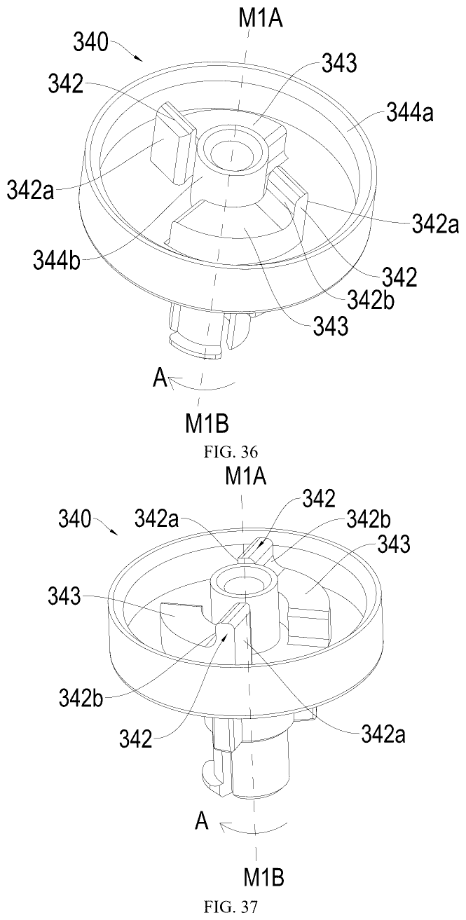

As shown in FIGS. 36 and 37, in certain embodiments, the drive force receiving portion 342 is a first protrusion extending from the end surface of the drum coupling 340. One side of the drive force receiving portion 342 is the drive force receiving surface 342a, which is perpendicular to the end surface of the drum coupling 340. The other side of the drive force receiving portion 342 is the braking force receiving surface 342b, which is configured opposite to the drive force receiving surface 342a. The braking force receiving surface 342b is a flat surface, and it is also perpendicular to the end surface of the drum coupling 340. That is, the braking force receiving surface 342b is parallel to the drive force receiving surface 342a and also parallel to the axis M1 of the drum coupling 340. The braking force receiving surface 342b, being parallel to axis M1, may not engage with the first braking force engagement member 204/second braking force engagement member 208.

As shown in FIGS. 36 and 37, the compression portion 343 in certain embodiments is configured at the downstream side of the drive force receiving portion 342 in the rotation direction A and is connected to the braking force receiving surface 342b. The compression portion 343 and the drive force receiving portion 342 in certain embodiments are also divided into two groups, and the two groups of compression portions 343 and drive force receiving portions 342 do not contact each other. The compression portion 343 acts on the braking force applying assembly to reduce or eliminate abnormal noise during the rotation of the drive force transmission member.

The above description illustrates certain embodiments of the present disclosure. For those skilled in the technical field, modifications and improvements may be made without departing from the inventive concept of the present disclosure, and these are all within the scope of protection of the present disclosure.

What is claimed is:

1. A processing cartridge detachably accommodated in an electronic imaging device, wherein the electronic imaging device includes a drum drive transmission unit, the drum drive transmission unit is axially extendable and retractable, an extension direction is towards the processing cartridge and a retraction direction is away from the processing cartridge, the drum drive transmission unit includes a braking force applying assembly and a drive force transmission member, and the processing cartridge includes:
a drum frame;
a photosensitive drum rotatably supported on the drum frame;
a drum coupling, configured at one end of the photosensitive drum, to engage with the drum drive transmission unit and receive drive force to rotate in rotation direction A, wherein the drum coupling includes a compression portion acting on the braking force applying assembly, and during engagement of the drum coupling with the drum drive transmission unit, the drum coupling abuts against the braking force applying assembly, causing the braking force applying assembly to move in the retraction direction, thereby reducing or eliminating abnormal noise during rotation of the drive transmission unit.

2. The processing cartridge of claim 1, wherein the compression portion protrudes from the end surface of the drum coupling, and a number of the compression portion is at least one.

3. The processing cartridge of claim 2, wherein the drum coupling includes a drive force receiving portion, the drive force receiving portion protrudes from the end surface of the drum coupling, and a side of the drive force receiving portion on an upstream side in the rotation direction A is a drive force receiving surface.

4. The processing cartridge of claim 3, wherein the compression portion is located on the downstream side of the drive force receiving portion in the rotation direction A.

5. The processing cartridge of claim 4, wherein a height of the compression portion protruding from the end surface of the drum coupling is less than a height of the drive force receiving portion protruding from the end surface of the drum coupling.

6. The processing cartridge of claim 5, wherein the drive force receiving portion is a first protrusion, the compression portion is a second protrusion, and one end of the first protrusion is connected to one end of the second protrusion.

7. The processing cartridge of claim 2, wherein the compression portion is a frustoconical structure.

8. The processing cartridge of claim 7, wherein an end surface of the drum coupling is configured with a third annular protrusion, and the compression portion is located within an inner circumference of the third annular protrusion.

9. The processing cartridge of claim 8, wherein there is an interval between the third annular protrusion and the frustoconical structure, and a height of the frustoconical structure is less than a height of the third annular protrusion.

10. The processing cartridge of claim 9, wherein the third annular protrusion has a notch, and one side surface of the notch in the circumference direction is a drive force receiving surface.

11. The processing cartridge of claim 9, wherein the third annular protrusion has a notch, and an inner wall of the third annular protrusion includes a drive force receiving portion, a position of the drive force receiving portion corresponds to a position of the notch, and the end surface of the drive force receiving portion facing the retraction direction is a drive force receiving surface.

12. The processing cartridge of claim 6, wherein a side surface of the drive force receiving portion includes a braking force receiving surface on a downstream side of the rotation direction A.

13. The processing cartridge of claim 12, wherein one end of the braking force receiving surface in the extension direction is connected to one end of the compression portion in the retraction direction.

14. The processing cartridge of claim 12, wherein the braking force receiving surface is a surface tilted axially relative to the drum coupling, and the braking force receiving surface is tilted relative to an upstream side of the rotation direction A along the retraction direction.

15. The processing cartridge of claim 12, wherein the braking force receiving surface is a flat surface parallel to an axial direction of the drum coupling.

16. The processing cartridge of claim 1, wherein the processing cartridge further comprises a braking member for providing braking force to the photosensitive drum.

17. The processing cartridge of claim 16, wherein a conductive bearing is configured at the other end of the photosensitive drum opposite to the coupling, and the braking member is configured at the conductive bearing and/or the drum coupling.

18. The processing cartridge of claim 17, wherein the braking member is a torsion spring.

19. The processing cartridge of claim 18, wherein a coil portion of the torsion spring is fitted onto the outer circumferential surface of the conductive bearing and/or the drum coupling and grips the conductive bearing and/or the drum coupling, and the arm of the torsion spring abuts against the drum frame, when the photosensitive drum rotates, torsion force of the torsion spring generates a braking force on the photosensitive drum.

20. The processing cartridge of claim 18, further comprising:
a conductive shaft pin, wherein the conductive shaft pin is inserted into the conductive bearing after partially extending through a through hole on the drum frame, the coil portion of the torsion spring is fitted onto the conductive shaft pin and grips the conductive shaft pin, the arm of the torsion spring abuts against the conductive bearing, and when the photosensitive drum rotates, the torsion force of the torsion spring generates a braking force on the photosensitive drum.

21. The processing cartridge of claim 20, wherein an inner wall of the conductive bearing is configured with ribs against which the arm of the torsion spring abuts.

22. The processing cartridge of claim 17, wherein the braking member is configured between the conductive bearing and the drum frame, and/or the braking member is configured between the drum coupling and the drum frame;
the braking member is capable of being compressed and deformed to generate friction force between the conductive bearing and the drum frame, and/or between the drum coupling and the drum frame; and
the friction force provides a braking force acting on the photosensitive drum.

23. The processing cartridge of claim 22, wherein the braking member is configured on an end surface or a circumference outer wall of the conductive bearing, and/or the braking member is configured on a circumferential outer wall of the drum coupling.

24. The processing cartridge of claim 23, wherein the conductive bearing and/or the drum coupling include an annular groove on circumferential outer wall for accommodating the braking member, and when the braking member is accommodated in the annular groove, at least a portion of which protrudes from the circumference outer wall of the conductive bearing and/or the drum coupling.

25. The processing cartridge of claim 22, wherein the braking member is a rubber ring or a rubber gasket.

26. The processing cartridge of claim 3, wherein the drum coupling includes a limiting portion for limiting or preventing relative tilting when the drum drive transmission unit engages with the drum coupling.

27. The processing cartridge of claim 26, wherein the limiting portion includes a first annular protrusion configured at an outer circumference of the drum coupling.

28. The processing cartridge of claim 27, wherein the first annular protrusion protrudes in the retraction direction, and an inner diameter of the first annular protrusion fits an outer diameter of a cylindrical portion of the drive force transmission member; when the drive force transmission member extends in the extension direction and engages with the drum coupling, the cylindrical portion extends into the first annular protrusion and contacts the first annular protrusion.

29. The processing cartridge of claim 26, wherein the limiting portion includes a second annular protrusion configured at a central axis of the drum coupling.

30. The processing cartridge of claim 29, wherein the second annular protrusion protrudes from the end surface of the drum coupling in the retraction direction, and the inner diameter of the second annular protrusion fits the outer diameter of the positioning protrusion of the drive force transmission member; when the drive force transmission member extends in the extension direction and engages with the drum coupling, a section of the positioning protrusion extends into the second annular protrusion and contacts the second annular protrusion.

31. The processing cartridge of claim 26, wherein the limiting portion includes an abutting protrusion extending from the end surface of the drum coupling.

32. The processing cartridge of claim 31, wherein the abutting protrusion and the drive force receiving portion are spaced apart in the circumference direction with an interval, and the interval fits the circumference width of the drive force transmission portion of the drive force transmission member; when the drive force transmission member extends in the extension direction and engages with the drum coupling, the drive force transmission portion is at least partially inserted into the interval between the abutting protrusion and the drive force receiving portion and abuts against both.
